(19) United States
(12) Patent Application Publication
(10) Pub. No.: US 2010/0211594 A1
(43) Pub. Date: Aug. 19, 2010

(54) METHOD OF AND SYSTEM FOR SENSOR SIGNAL DATA ANALYSIS

(75) Inventors: Julien Penders, Embourg (BE); Michael Rik Frans Brands, Antwerpen (BE)

Correspondence Address: KNOBBE MARTENS OLSON & BEAR LLP, 2040 MAIN STREET, FOURTEENTH FLOOR, IRVINE, CA, 92614, US

(73) Assignees: Stichting IMEC Nederland, Eindhoven (NL); I-Know, Diepenbeek (BE)

(21) Appl. No.: 12/636,631

(22) Filed: Dec. 11, 2009

Related U.S. Application Data
(63) Continuation of application No. PCT/EP2008/004772, filed on Jun. 13, 2008.
(60) Provisional application No. 60/944,060, filed on Jun. 14, 2007.

(51) Int. Cl. G06F 17/30

(52) U.S. Cl. 707/769; 707/E17.014

(57) ABSTRACT

A method and system for sensor signal data analysis are disclosed. In one aspect, a method includes acquiring sensor signal data from a plurality of sensors. Signal processing is performed on the sensor signal data to extract one or more features of the sensor signal data. The features are signal extracts that are distinguishable among and reproducible along the sensor signal data. With at least one of the features, a plurality of information attributes is associated, and information evaluation is performed on the plurality of information attributes.

### CROSS REFERENCE TO RELATED APPLICATIONS

This application is a continuation of PCT Application No. PCT/EP2008/004772, filed Jun. 13, 2008, which claims priority under 35 U.S.C. §119(e) to U.S. provisional patent application 60/944,060 filed on Jun. 14, 2007. Each of the above applications is incorporated herein by reference in its entirety.

### BACKGROUND OF THE INVENTION

1. Field of the Invention

The present invention relates to signal data analyses and, more particularly, to a method of and a system for sensor signal data analysis enabling semantic interpretation of sensor signal data.

2. Description of the Related Technology

It is anticipated that micro-system technology will increase the functionality of sensors and sensor networks to gradually match the needs of society in a broad spectrum of industries and applications, such as industrial automation, building automation, health and lifestyle, environment and agriculture, tracking and tracing, and many others.

Sensors to be used for these applications may comprise miniature sensor nodes of a sensor network, each of which has its own energy supply and data storage facilities. Each node may have a level of intelligence to perform a plurality of operations. Each node may be able to communicate with other sensor network nodes or a central node. The central node may communicate with the outside world using a standard telecommunication infrastructure and protocol, such as a wireless local area or cellular phone network. The sensor network might include feedback loops that provide control and automated processes within so-called closed-loop systems.

Sensor signal data are conventionally converted from analog to digital data and digitally analyzed by various signal processing techniques to extract features from the digitized signal data, relevant in the context of a particular application. Examples of signal processing techniques which are well-known to those skilled in the art include, but are not limited to, transforms (Fourier, Wavelets), integration, differentiation and derivation, thresholding, fitting to mathematical functions, etc.

Future sensor networks will become increasingly complex and able to measure a huge number of different parameters, both directly relating to an object or system to be monitored as well as object and system environmental parameters and conditions. It is foreseen that conventional signal processing techniques will by far not sufficient to optimally interpret and evaluate such a rich amount of dynamic sensor data. Neither will existing signal processing techniques be able to discover and interpret complex relations between the various sensor data to provide emerging trends, threats or risks and to translate these into appropriate actions and counter measures, such to avoid or reduce irreversible damages of the body or system to be monitored, for example.

US patent application 2005/0222811 discloses a method and apparatus for sensor signal data analysis based on context-sensitive event correlation. The term event represents a time-based fact, observation, action, process, or a change of state of a system. Event correlation is the process of inferring a new event or a new quality of an event from one or more existing events by one or more Event Correlation (EC) engines. The events produced by the EC are provided to one or more Situation Manager (SM) engines. A situation is a collection of one or more events that are related by at least one of temporal, spatial, logical, arithmetic, cause-and-effect, or modal constraints.

The SM operates by matching incoming events from sensors with stored typical, essential, significant or instructed situations, collectively called situation templates. The SM, among others, may also create new situation templates from existing situation templates according to the incoming events.

Situation based management as disclosed in this US patent application comprises event driven diagnostic, explanatory, control and predictive situation management, instantiated from a predefined catalog of situation templates for a given application domain.

### SUMMARY OF CERTAIN INVENTIVE ASPECTS

Certain inventive aspects relates to a sophisticated, generic method of sensor signal data analysis, adapted to evaluate and interpret sensor signal data of a plurality of sensors, a method of application specific decision making from sensor signal data. Certain inventive aspects relate to a system, means, sensors and sensor nodes for sensor signal data acquisition and analysis, adapted to evaluate and interpret a plurality of sensor signal data in the context of a particular application. Certain inventive aspects relate to a computer program for carrying out the method according to invention, when the computer program is loaded in a working memory of a computer and is executed by the computer, as well as a computer program product comprising the computer program.

In one aspect, a method of sensor signal data analysis comprises acquiring sensor signal data from a plurality of sensors; performing signal processing on the sensor signal data to extract one or more features of the sensor signal data, wherein the features are signal extracts that are distinguishable among and reproducible along the sensor signal data; associating with at least one of the features a plurality of information attributes; and performing information evaluation on the plurality of information attributes.

In one aspect, a method is based on the insight that besides the well-known physical signal parameters such as amplitude, phase, frequency, energy content, etc. by which measured signal data can be characterized and analyzed, additional reproducible signal extracts can be distinguished and identified among the sensor signal data, called features. These individual features may represent or point to properties, characteristics, concepts, relations and other descriptive information, called information attributes. As will be appreciated, these information attributes may also express relations of and between applications and application domains, if applicable.

In one aspect, by extracting such features from the sensor signal data and associating with these extracted features information attributes, it becomes possible to discover and interpret relations between various sensor data by performing an appropriate evaluation process on the information attributes associated with the respective features.

That is, besides the traditional analysis of the physical signal parameters and features or events by comparing same with a catalog of known situation templates according to US patent application 2005/0222811 disclosed above, one inventive aspect enables sensor signal data analysis based on the information attributes associated with features extracted from the acquired sensor signal data. By this type of analysis, the sensor signal data acquired in a complex sensor network can be interpreted and evaluated in a more sophisticated, coherent and intelligent manner compared to an analysis based on physical signal parameters and features or events alone.

As will be appreciated, by associating the information attributes to the features extracted from the sensor signal data, a certain amount of ambiguity will be introduced. Evaluation in the context comprises, but is not limited to, eliminating redundant attributes, combining attributes, reducing attributes, deducing further attributes from the attributes associated with the extracted features, excluding contradictory attributes, extending the number attributes based on the attributes already associated with the extracted features.

With the method according to one inventive aspect, future generations of sensors and sensor networks will provide not only feedback about the monitored body or system, but also interpretation of the sensor signal data under the format of structured information or knowledge, thereby enhancing the intelligence of the sensor network. In the field of healthcare, for example, an ECG monitoring system will not only provide feedback about an increased heart rate but will also suggest potential interpretations of this symptom, potential treatments and required immediate action. Similarly, activity monitoring devices will not only provide feedback about calories unbalance, but will also generate a set of actions to recover this balance, such as required physical exercises or diet modifications.

As already described in the pre-amble, features can be extracted from the sensor signal data using signal processing techniques which are well-known to those skilled in the art. To identify features in the sensor signal data, in a further embodiment of the invention, a feature database is provided, wherein the feature extraction comprises identification of features from this feature database. Features to be extracted from the sensor signal database are distinguishable (among the entire signal), reproducible (along the signal) and non-isolated. The feature database may be application domain dependent.

It will be appreciated that features may be dynamically identified and extracted that are not pre-defined and stored in a database, such as but not limited to averages, trends, etc.

Each feature extracted among the sensor signal data contributes to the information describing the system or object monitored by the sensor network. However, the piece of information carried in and with each of these features can be ambiguous. That is, it can refer to many states, of many elements in the system. Thus, in most cases, individual features will not lead to a univocal decision on the state of the overall system.

In a further embodiment of the method according to the invention, the process of feature extraction comprises identification of feature patterns among the extracted features, using a feature pattern database. Feature patterns may be identified in the time domain, frequency domain, time-frequency domain, in signal amplitude or signal shape and signal phase, for example. It will be appreciated that with these feature patterns further and different information attributes may be associated, thereby significantly enhancing the analyses of the sensor signal data.

Ambiguity creation can easily be understood in the static case, where the set of features are known and defined a priori. Once a feature is extracted and identified, a set of attributes that represent the information carried by the feature is associated therewith. In this process, the ambiguity implicitly contained in the feature is made explicit through association of information attributes. This process may also be referred to as ambiguity deployment or creation.

In one aspect, information attributes may be selected from a predetermined set of information attributes. By carefully selecting the set or sets from which information attributes are selected, the load on the evaluation of the information attributes can be reduced. The set from which information attributes are selected can be adjusted to a particular application or application domain, for example. It will be appreciated that such a set may be continuously updated by expert knowledge and other knowledge, such as by supervised and unsupervised learning and acquisition techniques gained in a particular application domain, in order to keep the sensor signal data analyses up to date. Such an update may be performed manually and/or in an automated manner.

Information attributes are of a descriptive nature. A particular class of information attributes which are valuable in the context of one inventive aspect are information attributes referring to the aspect of meaning of features, also called semantic attributes. One inventive aspect, in a further embodiment thereof, provides a novel approach to decision-making on the status of an object or system, by associating with the features or feature patterns semantic attributes, which may be selected from an application specific semantic database. In addition to the evaluation of the information attributes with respect to their information content, the semantic information is evaluated.

In one aspect, information attributes may comprise linguistic items, e.g. text i.e. words and sentences, image items among which graphical information, video items, sound items, and measurement items. In one embodiment of the invention, semantic attributes are represented in text form, i.e. words and sentences.

Future sensors will be of a generic nature. That is, these sensors are able to measure a plurality of physical properties, such as temperature, conductivity, etc. and within a particular range, for example. Signal processing and feature extraction, the association of the information attributes and the information evaluation can be further optimized and enhanced, in a further embodiment, by providing meta data.

The term meta data, in the context of the present description, refers in the broadest sense to data providing information about the data provided by the sensors, which meta data can be used to refine sensor data analysis and interpretation. Sensor meta data include, among others, data as to the actual physical property that is sensed, the resolution of the measurement, etc. Other meta data that may be included in the analysis comprise sensor network meta data, application meta data, and meta data of sensed phenomena.

Future generation of sensor network will include not only sensors that monitor a system or body itself, but also sensors that sense the environment in which the system is evolving, and the context of this evolution. For properly analyzing such environmental sensor signal data, the method, in a further embodiment thereof, comprises the process of providing context or environmental meta data, and performing the signal processing and feature extraction, the association of the information attributes and the information evaluation in accordance with the context or environmental meta data provided.

The network meta data may comprises information specific to the to the physical properties of the sensor network, such as bit rate, processing capacity, available storage and specific to the environment and context within which the system or body operates and evolves. In a sensor network environment, comprising several sensor nodes, data concerning network health/status, network management, routing of sensor signal data, distributed signal processing, etc. have to be properly queried and analyzed. From this information, prioritization information may be deducted for providing priority to one or some of the sensor signal data and features extracted there from, dependent on the network properties and the state of the surrounding environment of the system or body, for example. Depending on the context and the quality of the data acquisition, for example, some signals should receive more or less importance during the signal processing.

The network meta data are in general not static but may contain information with respect to the momentary sensor network architecture, such as which node or nodes are (dynamically) required in and are removed from the network. Context awareness also plays an important role here since, depending on the environment, the system might have to re-organize the network architecture. Within an unstable and ‘wild’ environment for instance, the system should focus on its survival and might thus be led to throwing some nodes out in order to allocate resources only to essential nodes. Accordingly, in one aspect, a level of network management has to be incorporated is to avoid both data and semantic information overload.

As will be appreciated, the application or application domain within which the sensor monitored system or body is deployed plays an important role in correctly analyzing the features extracted from the acquired sensor signal data and the selection and allocation of information attributes.

To this end, in a still further embodiment of the invention, the method comprises providing application meta data for at least two applications, and performing the signal processing and feature extraction, the association of the information attributes and the information evaluation using the application meta data. The applications will be preferably related. In a medical context, for example, when measuring parameters of the human body, applications from which to be select may be cardiology and angiopathy.

An important aspect of intelligent sensor signal data analysis is the ability to dynamically adapt to changing conditions and the automated creation of new features and patterns, as well as new information attributes. In one aspect, the method further may comprise some or each of the following:
adapting the feature extraction based on the information evaluation,
adapting the feature extraction based on information attributes associated with the features, and
adapting sensor and/or sensor network operations based on the information evaluation.

In particular in a sensor network environment, wherein sensors may operate as intelligent nodes in the network, one inventive aspect provides a comprehensive data flow in the network in that the features and the associated information attributes are structured as data objects, and each data object comprising a set of data fields. A data object may further comprise any of a group consisting of sensor meta data, sensor network meta data, context or environment meta data, application meta data, and meta data of sensed phenomena. In one aspect, relationships between data objects may be defined and a data object may comprise data management information, among others based on dynamic data object creation. That is, the data object is structured with (virtual) space to store all this information.

By structuring the data flow along data objects as disclosed above, a versatile information exchange and communication between and among nodes in a sensor network can be provided, wherein the communication comprises exchange of data objects. The data objects may be virtual data objects, and may or may not be compressed before communication. The sensor nodes may have a relatively simple structure, which is an important economical aspect in sensor networks comprised of a plurality of sensors.

In a further embodiment of the invention, wherein the sensor network comprises network nodes, including sensor nodes, the nodes are arranged for mutual communication of information. The exchange of data objects may be reduced and controlled by performing completely or partly at a network node at least one of acquiring sensor signal data, feature extraction, allocation of information attributes and evaluation of the information attributes.

In one embodiment of the invention, the communication with and between individual sensors and sensors in a network is wireless.

In a second aspect the invention also provides a method of application specific decision making from sensor signal data analyzed as disclosed above, which method comprises the process of processing, by a semantic engine, a result of the evaluation process, to produce semantic information.

To enhance the dynamics of the sensor signal data analysis, the semantic information, in a further embodiment of the invention, provides input for any of feature extraction and the association of information features.

When using a semantic engine for decision making, during the evaluation of the information attributes associated to the extracted features, it is sufficient to perform a partial disambiguation of the information attributes.

The type of decisions may range from, among others, control, display, measurement, alert, and actuation operations, decision support, automated update of data bases and other storage devices and applications or records, automated querying of data bases, and triggering applications external to a sensor network or system. Application domains at which certain inventive aspects may be applied include (human) body area networks, in particular medical and health control, gaming including various feedback to the gamer, and household and lifestyle applications.

One inventive aspect relates to a system for sensor signal data analysis, comprising means for acquiring sensor signal data from a plurality of sensors, processing means arranged for performing signal processing on the sensor signal data to extract one or more features of the sensor signal data, wherein the features are signal extracts that are distinguishable among and reproducible along the sensor signal data, means arranged for associating a plurality of information attributes with at least one of the features, and means for performing information evaluation on the plurality of information attributes.

In further embodiments of the system according to the invention, the processing means, the means for associating information attributes, the means for performing information evaluation, and further means are arranged and provided for performing the method as disclosed above.

One inventive aspect relates to a sensor and a sensor network for operation.

One inventive aspect relates to a system for sensor signal data analysis. The system comprises an acquiring module configured to acquire sensor signal data from a plurality of sensors. The system further comprises a processing module configured to perform signal processing on the sensor signal data by using signal processing techniques to extract one or more features of the sensor signal data, wherein the features are signal extracts comprising signal parameters and parts of the sensor signal data that are distinguishable among and reproducible along the sensor signal data. The system further comprises an association module configured to associate a plurality of information attributes with at least one of the features, the information attributes representing descriptive information relating to a feature. The system further comprises an evaluation module configured to perform information evaluation on the plurality of information attributes.

Certain inventive aspects may be practiced in hardware, in software and/or a combination of hardware and software. To this end, one inventive aspect relates to a computer program and a computer program product comprising program code means, which computer program functions to carry out the method as disclosed above, when the computer program is loaded in a working memory of a computer and is executed by the computer.

Further features and aspects of the present invention will be disclosed in the following detailed description by means of non-limiting examples and definitions, in conjunction with the enclosed drawings.

### BRIEF DESCRIPTION OF THE DRAWINGS

FIG. 1 shows schematically a general block diagram of a system for sensor signal data analyses in accordance with one embodiment.

FIG. 2 shows schematically the process of association of information attributes to features extracted from acquired sensor signal data, in accordance with one embodiment.

FIG. 3 shows schematically, in more detail, an embodiment of a feature extraction and data object generation module in accordance with one embodiment.

FIG. 4 shows schematically, in more detail, an embodiment of an information attribute association and evaluation module, in accordance with one embodiment.

FIG. 5 shows schematically, in more detail, an embodiment of a system management module in accordance with one embodiment.

FIG. 6 shows schematically, in a block diagram, an embodiment of a signal pre-processing module.

FIG. 7 shows schematically a sensor network in accordance with one embodiment, applied on a human body.

### DETAILED DESCRIPTION OF CERTAIN ILLUSTRATIVE EMBODIMENTS

In the above and the remainder of this description and the claims, the term “sensor” has to be construed in its broadest and most general meaning as a means for monitoring, including but not limited to sensors producing waveforms representing biological, physiological, neurological, psychological, physical, chemical, electrical and mechanical signals, such as pressure, sound, temperature and the like, probes, surveillance equipment, measuring equipment, and any other means for monitoring parameters representative of or characteristic for an application domain.

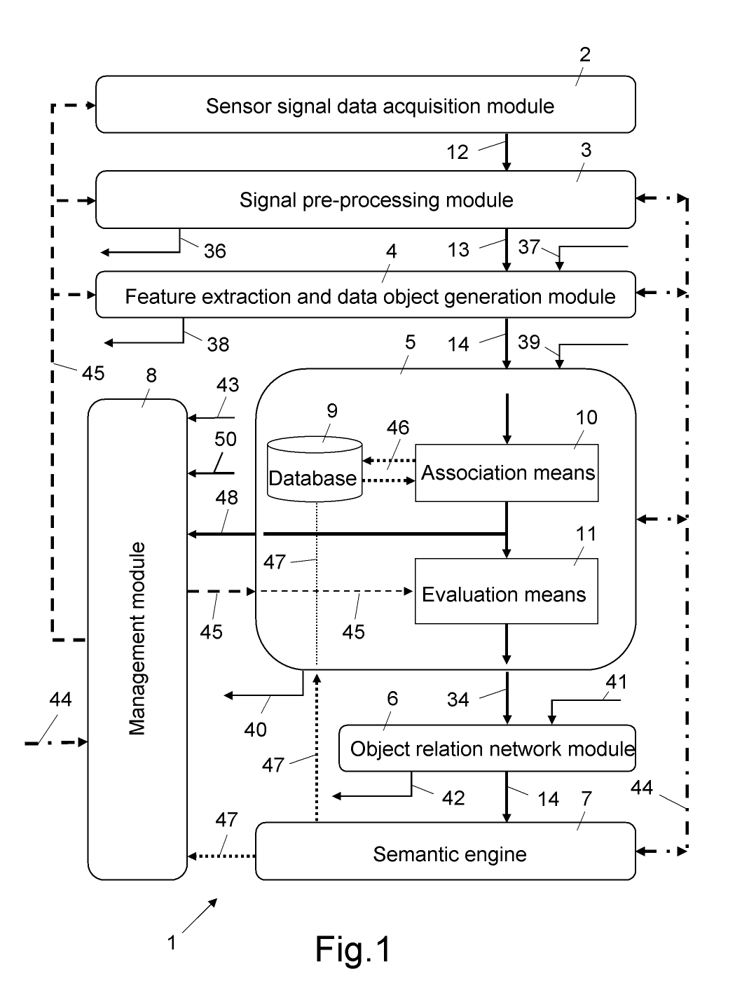

A general block diagram of a system 1 for sensor signal data analyses in accordance with one embodiment, is shown in FIG. 1. The system 1 comprises seven modules and each module performs a specific task in the sensor signal data analysis. The data processing workflow is continuous and the streaming information data flow runs from the top of the drawing to the bottom thereof and is indicated by solid bold arrows.

Sensor signal data are acquired by a data acquisition module 2, to which sensors (not shown) operatively connect. In general, the data acquisition module 2 acquires analog sensor signals from the various sensors. The sensors may be individual sensors and/or sensors connected in a sensor network. Data acquisition of sensor signal data as such is well known in the prior art, and for the purpose of describing the present invention no further description and discussion thereof seems required.

The acquired or sensed sensor signal data 12 are provided, by the data acquisition module 2, to a signal pre-processing module 3. The signal pre-processing module 3 is arranged for sampling of the analog sensor signal data and for conversion thereof from analog to digital data. In the signal pre-processing module 3 the sensor signal data can be filtered, amplified and further pre-processed using any of available electronic techniques, as known to the person skilled in the art.

In accordance with one embodiment, the signal pre-processing module 3 provides raw digital sensor signal data 13 to a feature extraction and data object generation module 4. In this feature extraction and data object generation module 4 one or more features, i.e. signal extracts or signal parts that are distinguishable among and reproducible along the sensor signal data are extracted from the sensor signal data of each of the sensors acquired by the data acquisition module 2.

General signal processing techniques can be used to extract features from digitized sensor signal data, such as various transform techniques (Fourier, Wavelets), by integration, derivation and differentiation techniques, by comparing physical features of the sensor signal data such as amplitude, frequency, phase to a set threshold or thresholds, by fitting the data to mathematical functions etc. All such signal processing techniques are known to the person skilled in the art.

For communication purposes, the features thus extracted are structured as data objects 14. A data object comprises a set of data fields and data objects may be of a virtual nature. The data objects 14 are provided to an information attribute association and evaluation module 5, in accordance with one embodiment.

In the information attribute association and evaluation module 5, a plurality of information attributes are associated with the extracted features of the sensor signal data. The information attributes to be associated may consist of linguistic items, image items, video items, sound items and measurement items, for example. As previously discussed, the information attributes represent descriptive information relating to an extracted feature. In the case of information attributes of the linguistic type, for example, the information attributes associated with a specific feature are represented by words and sentences in a human language. When, for example, measuring hearth rate and blood pressure of human being, the information attributes associated with features extracted from the respective sensor signal data may relate to written information concerning cardiology and angiopathy, for example. It will be appreciated that other information attributes may be associated with the extracted features, providing information related to the extracted features such as hearth rate curves of the human being, in accordance with one embodiment.

The information attribute association and evaluation module 5 is further arranged for performing information evaluation on the plurality of associated information attributes. Evaluation in the context of one embodiment may comprise any or all of elimination of redundant attributes, combination of attributes, reduction of the number of attributes, deduction of further attributes from attributes already associated with features, the exclusion of contradictory attributes, extension of the number of attributes, etc. The evaluation technique or techniques to be used will be based, as will be appreciated, on the type or types of information attributes associated with the features. In the case of linguistic information, using attributes consisting of descriptive words and sentences in a particular human language, such as the English language, for example, linguistic information evaluation techniques will be applied. In the case of video, pictorial or sound type information attributes, suitable video, picture and sound evaluation techniques will be used for performing information evaluation on the plurality of information attributes.

The result 34 of the evaluation process, i.e. a number of information attributes, is provided to an object relation network module 6. The object relation network module 6 is arranged for establishing how and linking the different data objects 14 together, based on similarities and other links in their context. Such a linking is advantageous in that each or several of the modules of the system 1 may be remotely arranged, for example.

The data objects 14, whether or not linked or structured as disclosed above, may be provided to a semantic engine 7, arranged for producing semantic information from the evaluation result of the information attribute association and evaluation module 5. The semantic engine 7 may be arranged, for example, for decision making from the information attributes associated to the extracted features of the sensed sensor signal data. Semantic engines for analyzing and performing decision making are known in the prior art. The type of semantic engine 7 to be used depends, inter alia, from the type of information attributes associated to the features of the sensor signal data, as described above.

As will be appreciated, for the overall management of the processing of the data flow, the system 1 comprises a management module 8. As can be viewed from FIG. 1, the management module 8 operatively connects to the sensor signal data acquisition module 2, the signal pre-processing module 3, the feature extraction and data object generation module 4, and the information attribute association and evaluation module 5, indicated by dashed bold arrows 45 in FIG. 1.

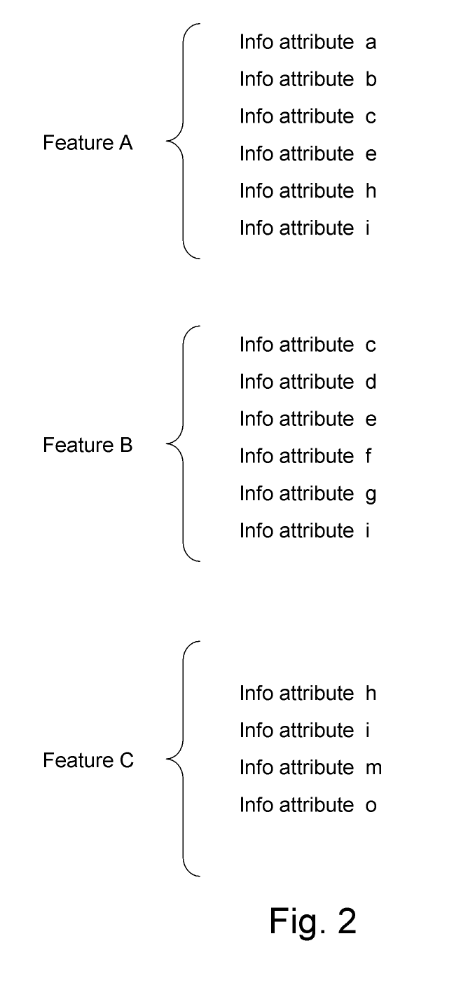

FIG. 2 shows schematically the process of association of information attributes to features extracted from the acquired sensor signal data, in accordance with one embodiment. In FIG. 2 it is supposed that three features A, B and C, respectively, have been extracted by the feature extraction and data object generation module 4 from the acquired and pre-processed sensor signal data.

In the information attribute association and evaluation module 5 a plurality of information attributes are associated to each of the respective features A, B, C. That is, with feature A information attributes a, b, c, e, h and i have been associated. To feature B information attributes c, d, e, f, g and i have been associated and to feature C the information attribute h, i, m and o have been associated, for example.

In accordance with one embodiment, the associated information attributes are evaluated by the information attribute association and evaluation module 5.

Suppose that the nature or type of sensors from which sensor signal data have been acquired are not known. By, for example, comparing the information attributes associated with feature A and feature B, it can be immediately seen from FIG. 2 that the information attributes c, e and i are common to feature A and feature B. In the event that these information attributes relate to temperature, for example, one may conclude that feature A and feature B both may provide sensor signal data concerning temperature measurement. If feature A is extracted from sensor signal data acquired from a first sensor and if feature B is extracted from sensor signal data acquired from a second sensor, the conclusion may be drawn that both the first and the second sensor may perform temperature measurement, for example. Depending on the other information attributes associated to the respective features, further conclusions may be drawn concerning the parameters and properties measured by the respective sensors.

When using general purpose sensors, from which it is beforehand not known what type of parameter is sensed, by evaluation of the information attributes associated to features extracted from the sensor signal data provided, it is possible to deduct what type of parameter, for example temperature, pressure, conductivity and the like is momentarily measured by a respective sensor.

In case it is a priori known from which type of sensor a respective feature is extracted, for example, by evaluating the information attributes associated with a respective feature or features, the conclusion may be drawn, for example, not to use the sensor data signal provided by a particular sensor because these data are redundant to the sensor signal data of another sensor.

The above are just a few examples of the information that can be gained from the information attributes associated to the extracted features in accordance with one embodiment. Different from the well-known physical features such as amplitude, phase, frequency, etc. On the basis provided, those skilled in the art will be able to deduct further information from the information attributes, without having to apply inventive skills.

In an embodiment of the present invention, the information attributes to be associated with the extracted features by the information attribute association and evaluation module 5 may be selected from a predetermined set of information attributes, stored in an information attribute database 9, as shown in FIG. 1 and schematically represented by dotted arrows designated by reference numeral 46. Reference numeral 10 denotes means for associating information attributes to the respective features received from the feature extraction and data object generation module 4, which means may take the form of suitably programmed processor means, for example. Reference numeral 11 denotes evaluation means for performing information evaluation on the associated information attributes. The evaluation means 11 likewise may be comprised by suitable processing means. Those skilled in the art will appreciate that the means 10 and 11 may be combined into a suitable programmed single processor means, for example. However, the means 10 and 11 may also be incorporated by special electronics hardware. It will be appreciated that features not necessarily need to be predefined and extracted in comparison with a database 9. Features such as averages, trends, risks, etc. may be calculated from the acquired sensor signal data.

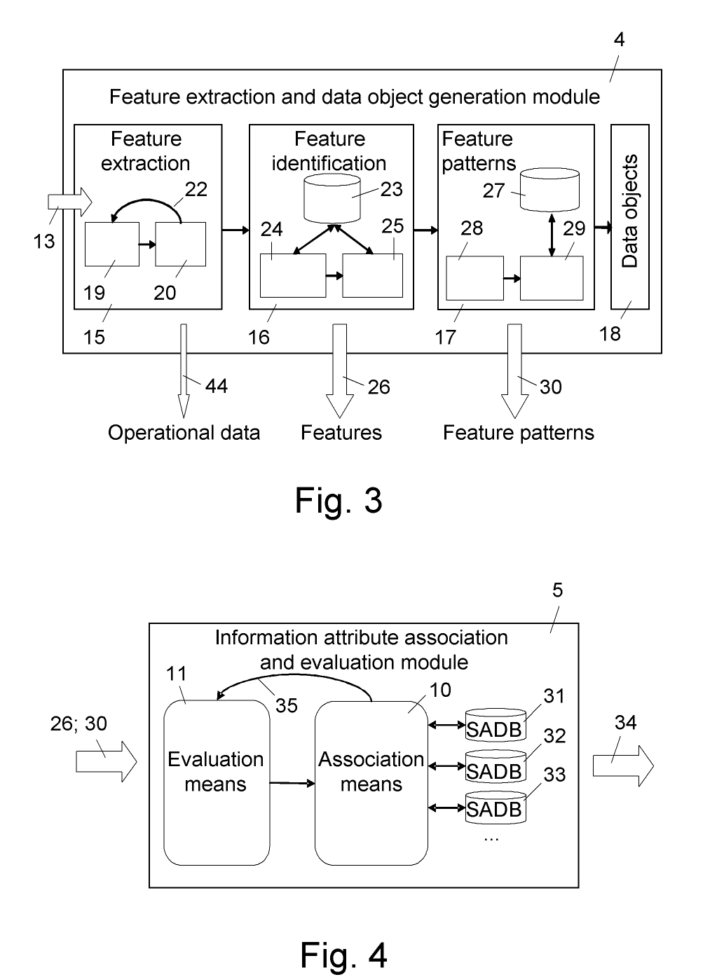

FIG. 3 shows in more detail an embodiment of the feature extraction and data object generation module 4 in accordance with one embodiment. The module 4 comprises four sub-modules, i.e. a feature extraction sub-module 15, a feature identification sub-module 16, a feature pattern identification sub-module 17, and a data object generation sub-module 18, respectively. The feature extraction sub-module 15 comprises means 19, 20 for extracting features from the raw digital sensor signal data provided to the feature extraction and data object generation sub-module 4, as indicated by arrow 13. The means 19 may be any suitable means for feature extraction known to the skilled person, such as means arranged for providing transforms, integration, differentiation, thresholding, etc. as disclosed above. The means 20 are arranged for dynamically adapting the feature extraction process, and may provide data concerning the extraction process, so-called operational data, schematically indicated by arrow 44.

Feature extraction is an inherent adaptive, dynamic process, as illustrated by the curved backward directed arrow 22, representing a feedback loop, and is performed on the sensor signal data acquired from each sensor. In one embodiment of the invention, however, features may be extracted without applying the feedback loop 22.

The next process, after the feature extraction, is identification of the extracted features, which is performed in the feature identification sub-module 16. Known features are stored in a feature database 23. Comparison means 24 identify features in the database 23 from the extracted features provided by the feature extraction sub-module 15. Means 25 are arranged for adding new features to the feature database 22, provided by the feature extraction sub-module 15. The thus extracted features are schematically represented by arrow 26. As will be appreciated, the feature identification process is likewise inherently dynamic. However, in a simplified embodiment of the system according to the invention, features may be identified using a fixed set of features.

Although single features may be identified and processed, for an enhanced analysis of sensor signal data in accordance with one embodiment feature patterns may be identified and processed. Feature patterns may occur in the time domain, frequency domain, time-frequency domain, morphology domain, i.e. signal shape, and phase domain of a sensor signal.

The feature pattern identification sub-module 17 comprises a feature pattern database 27, pattern detection means 28 and pattern recognition means 29. A feature pattern detected by the means 28 is provided to the pattern recognition means 29. The means 29 query the database 27, in order to identify a feature pattern. Feature patterns not known in the database 27 may be added thereto by the means 29, for future use. In this way, feature pattern identification is also an inherent dynamic process. Feature patterns that have been identified are schematically represented by arrow 30.

For an efficient system internal and external exchange of features, data objects are created as schematically indicated by data object creation means 18.

As will be appreciated by those skilled in the art, the sub-modules 15, 16, 17 and 18 may be provided both in hardware and/or software using suitable programmed data processing and storage devices. For clarification purposes, the sub-modules 15, 16, 17, 18 and their respective means are disclosed as separate units. However, it will be appreciated that the feature extraction and data object generation module 4 may be realized in a single processing device.

FIG. 4 shows schematically, in more detail, an embodiment of the information attribute association and evaluation module 5, in accordance with one embodiment. Features 26 and feature patterns 30 are provided to the information attribute association and evaluation module 5 from the feature extraction and data object generation module 4. The module 5 comprises information attribute association means 10 and information attribute evaluation means 11. In one embodiment, the attribute association means comprises an attribute association module. In one embodiment, the information attribute evaluation means comprises an information attribute evaluation module.

In accordance with an embodiment of the invention, the attribute association means 10 are arranged for selecting information attributes to be associated to a feature 26 and/or feature pattern 30 from a predetermined set stored, for example, in the information attribute database 9, as shown in FIG. 1.

In a further embodiment of the invention, the information attributes may be selected from a plurality of semantic attribute databases 31, 32, 33, . . . , shown in FIG. 4. Each of the semantic attribute databases 31, 32, 33, . . . , may comprise information attributes of a particular type such as linguistic attributes, video attributes, etc. as disclosed above.

The set of information attributes resulting from the evaluation of the information attributes associated to particular features is schematically indicated by reference numeral 34. The set 34 is provided to the object relation network module 6, see FIG. 1.

As indicated by the curved arrow 35 in FIG. 4, representing a feedback loop, information association in accordance with one embodiment is a dynamic process. By associating information attributes to features and feature patterns, ambiguity implicitly contained in a feature or pattern is made explicit through the association of descriptive information attributes. This process can also be called ambiguity deployment or creation. By properly evaluating the associated attributes, it may turn out that with some features other information attributes may have to be associated than provided for in one of the databases 9, 31, 32, 33, for example. It may also turn out that with some of the extracted features no information attributes can be associated, for example. However, by a proper evaluation of the other associated features and the context or application domain in which the sensor signal data are acquired or from data specific to a sensor, a sensor network or one or several applications, it may be possible to identify information attributes to be associated with such a feature.

Future generations of sensor systems and sensor networks will include not only sensors that monitor the system itself, such as the human body in the case of a body sensor network, but also sensors that sense the context and environment in which the system is evolving. Context and environment monitoring are emerging within the field of sensor network and will lead to context and environment aware sensor networks. Such context and/or environment awareness data, schematically indicated by arrow 50 in FIG. 1, add on to the sensory data itself to enable the embedment of the sensor monitoring process in the surrounding environment.

It will be appreciated that information or data specific to a sensor, a sensor network, an application or an application domain, a context and/or environment wherein the system operates and the sensed phenomena, in the remainder designated by the suffix ‘meta data’, may be additionally used in the processing of each of the above disclosed feature extraction and data object creation module 4, the information attribute association and evaluation module 5, the object network module 6 and the management module 8. Such meta data input and data output of the respective modules, including the means required for such a data input and output are schematically indicated by arrows 36-43 and 50 in FIG. 1.

Each of the modules 2, 3, 4 and 7 may provide additional data relating to their processing operations, called operational data. These operational data, including command line data, may be exchanged among the modules for enhancing and supporting the information processing, which is schematically indicated by dashed dotted bold arrows 44 in FIG. 1.

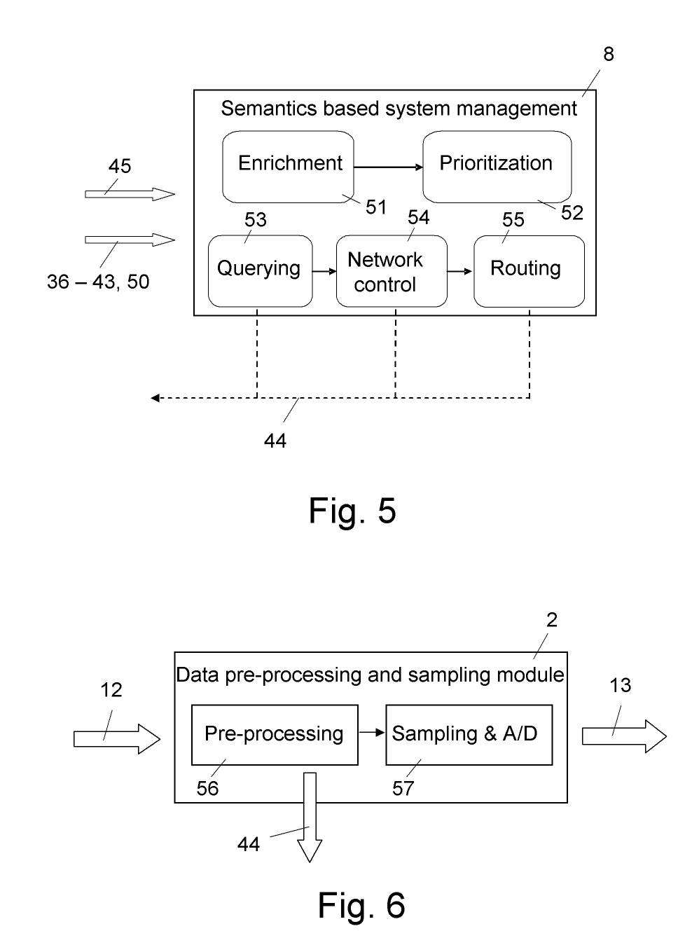

For effectively processing the meta data, i.e. sensor meta data, sensor network meta data, application meta data, meta data of sensed phenomena and context and/or environment meta data, the system 1 according to one embodiment, in an embodiment thereof, is provided with a semantics-based system management module 8, as shown in FIG. 1 and which is shown in more detail, according to an embodiment of the present invention, in FIG. 5.

The semantics-based system management module 8 uses the above-mentioned additional data, i.e. the meta data 36-43, 50 and the operational data 44, and aims at enriching and prioritizing of the information, and deployment of the semantics framework required for sensor and sensor network management.

For information enrichment and prioritization, enrichment means 51 and information prioritization means 52 are provided, performing the process of integrating operational data 44 and meta data 36-43, 50 to characterize the sensory data and define priorities and confidences on the various multi-modal information pieces. This enrichment is important since depending on the context and the quality of the data acquisition, some signals should receive more or less importance during the information evaluation by the information attribute association and evaluation module 5 and the disambiguation by the semantic engine 7.

The semantics-based system management further comprises semantics querying means 53 for network health, status or other punctual information. In the case of querying for network health/status, the management software should enquire each sensor for its status, sensory data and meta data in order to decide whether this sensor node is healthy, well-positioned and so on. In a sensor network, each network node may be queried by the querying means 53.

Semantics-based network control 54 includes management of network architecture based on sensors and network nodes dynamically required in and removed from the network. Context awareness also plays an important role here since, depending on the environment, the system might have to re-organize the network architecture. Within a wild environment for instance, the system should focus on its survival and might thus be led to throwing some nodes or sensors, out in order to allocate resources only to essential sensors and/or nodes. Another important reason for a semantics-based organization is to avoid data and semantic overload in the system 1. To this end, information from the information attribute association and evaluation module 5 is directly fed into the management module 8, as indicated by arrow 48.

Semantics-based routing means 55 are important for a high-scale network, to maintain the data flow through the system 1.

The means 53, 54, 55 connected to the command line or bus 45, for controlling the different modules 2, 3, 4 and 5 as shown in FIG. 1.

The semantic engine 7 provides feedback to the information attribute association and evaluation module 5 and the management module 8, as indicated by dotted arrows 47 in FIG. 1. In this manner an overall semantic adaptive system is provided, wherein the operation of the information attribute association and evaluation module 5 is enhanced and supported by the semantic engine 7.

FIG. 6 shows schematically, in a block diagram, an embodiment of the signal pre-processing module 3. The signal pre-processing module comprises pre-processing means 56 for filtering, amplification, etc. and sampling and analog to digital conversion means 57, to provide raw digital sensor signal data 13.

It will be appreciated by those skilled in the art that the signal processing already provided for by the pre-processing module 3 may be advantageously used in addition to the sensor signal data analysis based on the information attributes, as disclosed above.

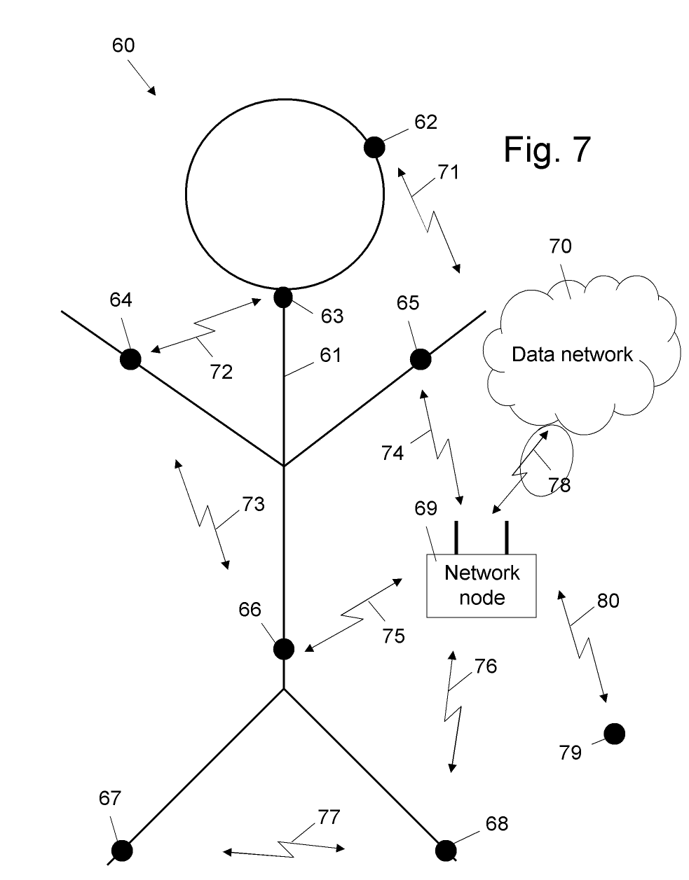

FIG. 7 shows in a very schematic form, a sensor network 60 applied in relation to and on a human body 61. The bold dots 62-68 represent various sensors and/or sensor nodes of the sensor network 61. The sensors may be special purpose and/or general purpose sensors, adapted for measuring just one or a number of physical parameters, such as temperature, noise, pressure, conductivity and so on.

The sensors 62-68 are arranged for wireless communication with a network node 69 of the sensor network. Sensors may also communicate directly with each other. The various wireless communication links are indicated by double arrows 71-77. The network node may connect wireless 78 to a data network 70, such as the Internet or an Intranet or other data network, for the exchange of information with one or more of the processing modules 2-6 of the system 1, as discussed above and shown in FIG. 1.

One or more of the sensors 62-68 may arrange for performing part of the processing tasks of the modules 2-6 of the system 1, and may operate as sensor network nodes.

For sensing environmental conditions, a sensor 79 is disclosed, which likewise communicates wirelessly 80 with the network node 69.

Those skilled in the art will appreciate that some or all of the sensors 62-68 may connect hard-wired to the network node 69.

For the purpose of standardized communication between modules within the system 1, as well as for the purpose of communication between sensors and network nodes, the information data flow in the system 1 and/or external thereof is preferably structured into data objects, as disclosed above. Table 1 below provides an overview of the fields of a data object, in an embodiment of the invention.

TABLE 1

| | Field | Type | Value (range) |
|---|---|---|---|
| High level | Application ID | u8int | 1-255 |
| | Application status | boolean | {on\|off} |
| | Network ID | u8int | 1-255 |
| | Network status | boolean | {on\|off} |
| Sensing | Sensor ID | u8int | 1-255 |
| | Sensor status | boolean | {known\|unknown} |
| | Sensor localization | char | {place} |
| | Sens-channel ID | u8int | 1-255 |
| | Sens-ch status | char | {known\|unknown} |
| | Sensor-ch type | char | {EEG\|ECG\|EMG\| . . . } |
| | Sensor type status | char | {know\|undetermined} |
| | Sensor gain | int | {1 . . . 10k} |
| | Sensor BW | int | {0 . . . 1M} kbps |
| Pre-processing | Sampling freq | int | {0 . . . 10k} Hz |
| | Filtering | char | {none; type_filter; order_filter} |
| Object creation | Object ID | u8int | 1-255 |
| | Object status | boolean | {on\|off} |
| | Object coding | u8int | 1-255 |
| | Object history | list of char | {char1, char2, char3, . . . } |
| | | Contains historic | |
| | | of object events | |
| | Obj time stamp | date/time | {dd:mm:yy & hh:mm:ss} |
| | Object info path | list of u8int | {sensor1, sensor2, . . . } |
| | | Contains list of | |
| | | sensors ID | |
| | Object info quality | char | {poor\|medium\|high\| . . . } |
| | S/N ratio | int | {0 . . . 1M} |
| | Feature ID | u8int | 1-255 |
| | Feature status | boolean | {on\|off} |
| | Feature type | char | {simple\|composed} |
| | Feature | variable | set_of_coefficients; value; |
| | | | template; . . . |
| | Feature on-set | date/time | {dd:mm:yy & hh:mm:ss} |
| | Feature off-set | date/time | {dd:mm:yy & hh:mm:ss} |
| | Feature metadata | List of char | {charact1, charact2, charact3, |
| | | Contains | . . . } |
| | | characteristics of | |
| | | the feature | |
| Amb. creation | Complete | Arborescence (3- | Lev1: object |
| | candidate meaning | levels tree) | Lev2: signal classes |
| | tree | before meaning | Lev3: possible meanings |
| | | rule-out | |
| | Actualized | Arborescence (3- | idem |
| | candidate meaning | levels) | |
| | tree | after meaning rule- | |
| | | out | |
| | Actualization flag | boolean | {tree\|compliment} |
| | | contains info on | |
| | | whether the tree | |
| | | itself or its | |
| | | compliment is | |
| | | store | |
| | Object relation net | network | |
| Syst Mngt | Object priority | int | {1 . . . 10} |

One skilled in the art of computer programming may realize the above described modules and means by computer processing devices arranged for performing the steps and functions disclosed.

One embodiment relates to a computer program, comprising program code means, which computer program functions to carry out the steps and processing according to certain embodiments, when loaded in a working memory of a computer and executed by the computer. The computer program may be arranged for being integrated in or added to a computer application for joint execution of the computer program and the computer application by a computer. The computer program may be arranged as program code means stored on a medium that can be read by a computer, and arranged for integrating the program code means in or adding the program code means to a computer application for joint execution of the program code means and the computer application by a computer.

Parts of the foregoing embodiments may be provided as a computer program product which may include a machine-readable medium having stored thereon instructions which may be used to program a computer (or other electronic devices) to perform a process according to one embodiment. The machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electromagnetic Erasable Programmable Read Only Memories), magnetic or optical cards, flash memory, or other type of media/machine-readable medium suitable for storing electronic instructions.

Moreover, parts of the foregoing embodiments may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, a carrier wave shall be regarded as comprising a machine-readable medium.

The invention is not limited to the examples and embodiments disclosed above and the accompanying drawings. Those skilled in the art will appreciate that many additions and modifications can be made based on the inventive idea embodied in the present description and drawings, which additions and modifications are to be comprised by the attached claims.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

What is claimed is:

1. A method of analyzing sensor signal data, comprising:
(a) acquiring sensor signal data from a plurality of sensors;
(b) performing signal processing on the sensor signal data by using signal processing techniques to extract one or more features of the sensor signal data, wherein the features are signal extracts comprising signal parameters and parts of the sensor signal data that are distinguishable among and reproducible along the sensor signal data;
(c) associating with at least one of the features a plurality of information attributes, the information attributes representing descriptive information relating to a feature; and
(d) performing information evaluation on the plurality of information attributes.

2. The method according to claim 1, wherein the feature extraction comprises at identifying features from a feature database or identifying feature patterns from a feature pattern database.

3. The method according to claim 1, wherein the information attributes comprise at least one of the following: semantic attributes, linguistic items, image items, video items, sound items, and measurement items.

4. The method according to claim 1, further comprising:
providing meta data of at least one of the group of sensor meta data, context or environment meta data, meta data of sensed phenomena, sensor network meta data, application meta data for at least two applications; and
performing at least one of the processes (b), (c) and (d) using the application meta data.

5. The method according to claim 1, further comprising:
adapting the feature extraction based on a result of the process (d);
adapting the feature extraction based on information attributes associated with the features;
adapting sensor operations based on a result of the process (d); and
adapting sensor network operations based on a result of the process (d).

6. The method according to claim 1, wherein the features and the associated information attributes are structured as data objects, each data object comprising a set of data fields, wherein a data object further comprises any of the following: sensor meta data, sensor network meta data, context or environment meta data, application meta data, meta data of sensed phenomena, and data management information.

7. The method according to claim 1, wherein at least one of the processes (a), (b), (c) and (d) is at least partially performed by a sensor and/or a sensor network node.

8. The method accordingly to claim 1, wherein the method is performed by one or more computing devices.

9. A computer-readable medium having stored thereon instructions which, when executed by a computer, performs the method according to claim 1.

10. A method of making application specific decision from sensor signal data obtained according to the method of claim 1, comprising processing a result of the process (d) by a semantic engine to produce semantic information.

11. The method according to claim 10, wherein the semantic information is used for at least one of a control, display, measurement, alert, actuation, decision-support, querying, and triggering operation and automated update of data bases, storage devices, records and applications.

12. A system for sensor signal data analysis, comprising:
an acquiring module configured to acquire sensor signal data from a plurality of sensors;
a processing module configured to perform signal processing on the sensor signal data by using signal processing techniques to extract one or more features of the sensor signal data, wherein the features are signal extracts comprising signal parameters and parts of the sensor signal data that are distinguishable among and reproducible along the sensor signal data;
an association module configured to associate a plurality of information attributes with at least one of the features, the information attributes representing descriptive information relating to a feature; and
an evaluation module configured to perform information evaluation on the plurality of information attributes.

13. The system according to claim 12, wherein the processing module is configured to perform signal processing are configured to either identify features from a feature database or identify feature patterns from a feature pattern database.

14. The system according to claim 12, wherein the association module is configured to select information attributes from a group of semantic attributes, linguistic items, image items, video items, sound items, and measurement items.

15. The system according to claim 12, further comprising a providing module configured to provide, meta data of at least one of a group of sensor meta data, context or environment meta data, meta data of sensed phenomena, sensor network meta data, and application meta data for at least two applications, to at least one of the processing module, the association module, and the evaluation module.

16. The system according to claim 12, wherein the processing module is configured to adapt the feature extraction based on a result of at least one of the evaluation module and the association module.

17. The system according to claim 12, wherein at least one of the sensors is configured to adapt sensor operation based on a result of the evaluation module.

18. The system according to claim 12, further comprising a semantic engine configured to produce semantic information based on a result of the evaluation module.

19. The system according to claim 18, wherein the semantic engine is arranged for at least one of a control, display, measurement, alert, actuation, decision-support, querying, and triggering operation and automated update of data bases, storage devices, records and applications.

20. The system according to claim 12, further comprising a computing environment operative to execute the modules, the computing environment comprising at least one computing device.

21. A system for sensor signal data analysis, comprising:
means for acquiring sensor signal data from a plurality of sensors;
means for performing signal processing on the sensor signal data by using signal processing techniques to extract one or more features of the sensor signal data, wherein the features are signal extracts comprising signal parameters and parts of the sensor signal data that are distinguishable among and reproducible along the sensor signal data;
means for associating a plurality of information attributes with at least one of the features, the information attributes representing descriptive information relating to a feature; and
means for performing information evaluation on the plurality of information attributes.
